(19) United States
(12) Patent Application Publication
(10) Pub. No.: US 2018/0201010 A1
(43) Pub. Date: Jul. 19, 2018

(54) SCREEN PRINTING LIQUID METAL

(71) Applicant: Microsoft Technology Licensing, LLC, Redmond, WA (US)

(72) Inventors: Siyuan Ma, Bothell, WA (US); James David Holbery, Bellevue, WA (US); Andrew Lewis Fassler, Seattle, WA (US); Collin Alexander Ladd, Sammamish, WA (US)

(73) Assignee: Microsoft Technology Licensing, LLC, Redmond, WA (US)

(21) Appl. No.: 15/409,372

(22) Filed: Jan. 18, 2017

(51) Int. Cl. B41F 15/08; B41F 17/38

(52) U.S. Cl. CPC B41F 15/0868; B41F 17/38

(57) ABSTRACT

Examples are disclosed that relate to screen printing liquid metal materials. One example provides a method to deposit a metal pattern onto a substrate. The method includes placing a textile over the substrate, the textile having a plurality of pores wettable by a liquid metal. The method further includes forcing the liquid metal through the pores of the textile and onto the substrate, and separating the substrate and textile.

### BACKGROUND

Printing technologies have advanced significantly in recent years. Ink-jet printing, for example, can now be used with various exotic inks and substrates, resulting in functionally patterned surfaces for electronic and optical components. Ink-jet printing is limited, however, in terms of speed and scalability. Often it is desirable to pattern large substrates with a coating at high manufacturing speed. In this scenario, traditional screen printing technologies may be attractive.

### SUMMARY

Examples are disclosed that relate to screen printing liquid metal materials. One example provides a method to deposit a metal pattern onto a substrate. The method comprises placing a textile over the substrate, the textile having a plurality of pores wettable by a liquid metal. The method further comprises forcing the liquid metal through the pores of the textile and onto the substrate, and separating the substrate and textile.

This Summary is provided to introduce in a simplified form a selection of concepts that are further described in the Detailed Description below. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example flexible component of an electronic device.

FIG. 2 shows an example screen printing apparatus and substrate.

FIG. 3 shows an example screen printing textile.

FIG. 4 illustrates an example method to deposit a metal pattern onto a substrate.

### DETAILED DESCRIPTION

Aspects of this disclosure will now be described by example and with reference to the drawing figures listed above. Components, process steps, and other elements that may be substantially the same in one or more of the figures are identified coordinately and are described with minimal repetition. It will be noted, however, that elements identified coordinately may also differ to some degree. It will be further noted that the figures are schematic and generally not drawn to scale. Rather, the various drawing scales, aspect ratios, and numbers of components shown in the figures may be purposely distorted to make certain features or relationships easier to see.

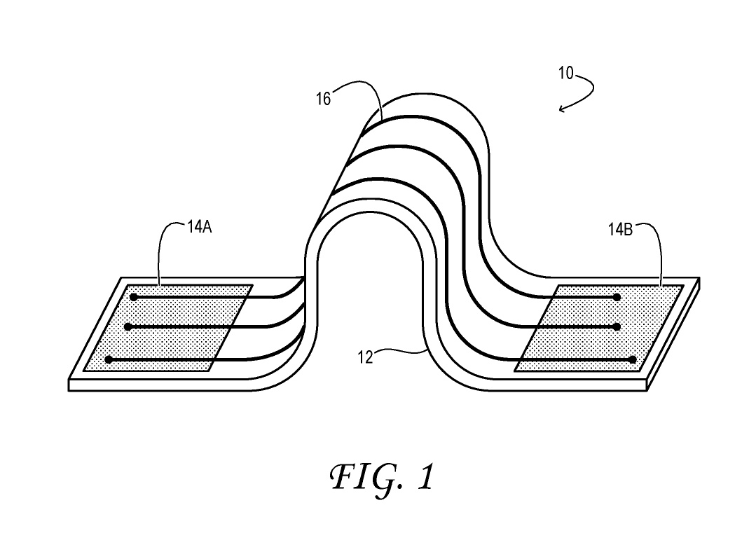

FIG. 1 shows aspects of an example flexible component 10 of an electronic device. The flexible component includes a substrate 12 with electronic circuits 14A and 14B mounted thereon. Further, a metal pattern 16 is deposited onto the substrate to provide electrically conductive pathways, or traces, from one electronic circuit to another.

In user-wearable or otherwise flexible electronic components, substrate 12 and metal pattern 16 may be intended to flex or bend a very large number of cycles without breaking. To this end, the substrate may include a flexible elastomer such as silicone, and the metal pattern may include a liquid metal, such as gallium or an alloy of gallium, indium and/or tin, as non-limiting examples.

Due to its speed, scalability and technological simplicity, screen printing is an attractive method for patterning a coating onto a substrate. Moreover, screen printing can be used for patterns that cannot be deposited in a single stenciling step. However, screen printing liquid-metal coatings poses difficulties not found with screen printing of ordinary inks. For example, liquid metals exhibit very high surface tension (up to about 10 times the surface tension of water at room temperature,) and may form a surface oxide layer, making them unable to wet the mesh materials used in conventional screen printing (e.g., polyester and cotton). This effectively excludes the liquid metal from the pores of the mesh. Excluded from the pores, the liquid metal is unable to pass through to the substrate, except under extreme pressures higher than those provided by conventional screen printing techniques. The pressure requirement makes liquid-metal screen printing unusable for many substrates, and much more expensive than screen printing a conventional coating.

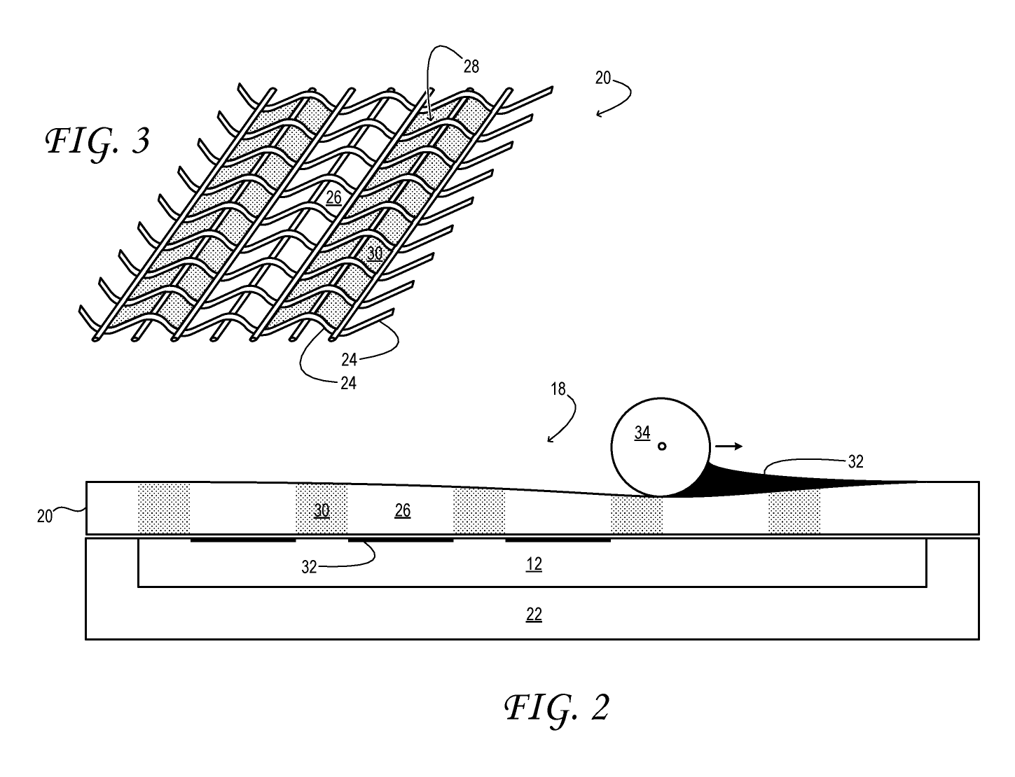

Accordingly, disclosed herein are a series of approaches to address the above issues and thereby allow practical, low-cost screen printing of liquid metal. FIG. 2 shows aspects of an example screen printing rig 18 with substrate 12 positioned thereon. The screen printing rig includes a textile 20 configured for screen printing a metal pattern onto the substrate. In FIG. 2, the textile is stretched over a rigid frame 22 to ensure flatness and accurate registration of the pattern on the textile (vide infra) to the underlying substrate.

FIG. 3 provides a schematic close-up view of textile 20 in one implementation. As shown in this drawing, textile 20 comprises an intimate arrangement of metal-containing fibers 24 defining a plurality of initially unfilled pores 26 wettable by a liquid metal. In the illustrated example, the intimate arrangement of metal-containing fibers includes a knit or woven mesh. In other examples, the intimate arrangement of metal-containing fibers may be non-woven or felted. In these and other examples, the intimate arrangement of metal-containing fibers may take the form of a screen.

Metal-containing fibers 24 may be wholly or substantially metallic in some examples. They may comprise a pure metal, an alloy of pure metals, or an alloy of one or more pure metals and non-metallic or semi-metallic impurities or dopants. In other examples, the metal-containing fibers may be metalized on the surface. In both cases, the metal-containing fibers may include, for instance, one or more of copper, silver, gold, nickel, iron, and tin. These metals are found to be effectively wetted by gallium containing alloy, such as a gallium-indium eutectic and/or galinstan liquid metals, under suitable conditions.

Without tying this disclosure to any particular theory, the wetting of the above metals by the liquid metal may occur reactively—i.e., through the alloying of a surface layer of the metals with the liquid metal. By inference, any solid metal that alloys with the desired liquid metal under suitable conditions is a candidate for textile fibers 24. On the other hand, it is also desirable for textile 20 to be suitably resistant to corrosion by the liquid metal, and thereby exhibit a long service life. In some screen printing implementations, copper is found to provide a good trade-off between wettability and corrosion resistance. Indium, under suitable conditions, may also be a useful candidate for the textile, because prolonged contact between indium and a gallium-indium containing alloy is expected to result in a dynamic equilibrium in which no metal is lost from the textile in a net sense.

Continuing in FIG. 3, a pore-filling solid may permeate the intimate arrangement of metal-containing fibers 24 within one or more defined areas 28, thereby defining a pattern of filled pores 30 among the unfilled pores 26. In some examples, the pore-filling solid includes a cured resin.

Returning now to FIG. 2, liquid metal 32 effectively wets the metal-containing fibers 24 of textile 20. The wetting force overcomes the significant surface tension of the liquid metal and allows the liquid metal to pass easily through the pores. As a result, a conventional roller 34 or squeegee is sufficient to mechanically force the liquid metal through the unfilled pores of the textile and onto substrate 12. After printing, the liquid metal may be covered with an encapsulant (e.g. a silicone material) or otherwise processed to fix the printed pattern in place.

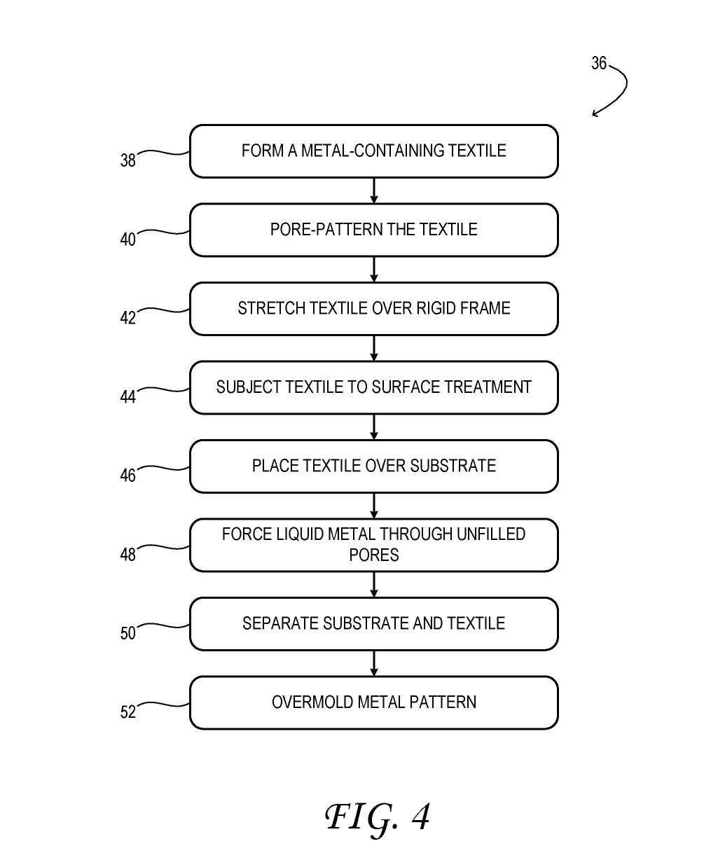

FIG. 4 illustrates an example method 36 to deposit a metal pattern onto a substrate.

At 38 of method 36, a metal-containing textile is formed. In some examples, forming the metal-containing textile includes weaving or knitting the textile from metal wires to form an overlapping weave pattern. In other examples, the act of forming the metal-containing textile includes metalizing a precursor textile. The precursor textile can be metalized via electroless deposition of a metal into a pore structure of the precursor textile, in some examples. In one example, a polyester precursor textile of mesh 195 (195 threads per inch) is immersed in an aqueous copper(II) solution to which a reducing agent is added. Suitable reducing agents include formic acid, formaldehyde, hydrazine, and hydroxylamine, as examples. Further details and further examples will be known to one skilled in the art of electroless deposition of metals. In other examples, a nylon precursor textile may be used. In still other examples, the precursor textile may be metalized by vacuum deposition, physical or chemical vapor deposition, and the like.

As noted above, the textile used for screen printing may be pore-patterned in some examples. At 40 of method 36, therefore, the textile is pore-patterned by filling the pores within a defined area of the textile. This action defines a pattern of filled and unfilled pores on the textile, which ultimately will be transferred onto the substrate. In some examples, the act of filling the pores may include applying a curable resin to the defined area of the textile and then curing the resin. The type of resin and the curing thereof is not particularly limited. The resin may be thermally cured or photocured UV-cured) using a mask bearing the desired pattern, for instance. At 42 of method 36, the textile is stretched over a rigid frame.

At 44 of method 36, the textile is optionally subjected to surface treatment to improve wettability by the liquid metal. The surface treatment may include treatment with one or more of a detergent such as an anionic surfactant, a degreasing base such as ammonia or trisodium phosphate, an oxidant such as hydrogen peroxide or sodium hypochlorite, a surface-oxide dissolving acid such as hydrochloric acid, a solvent such as water or acetone, and a drying agent such as steam, compressed air, and/or nitrogen. At 46 the textile is then placed over the substrate.

At 48 the liquid metal is forced through the unfilled pores of the textile and onto the substrate. The same printing screen may be used repeatedly for numerous screen-print applications of liquid metal. The composition of the liquid metal is not particularly limited; it may include gallium, or an alloy comprising gallium with indium and/or tin, such as gallium-indium eutectic or galinstan. Typically, the liquid metal is forced through the unfilled pores mechanically—e.g., by using a conventional roller or squeegee. In other examples, compressed air or a compressed gas may be used along with, or instead of the roller or squeegee. At 50 the substrate and textile are separated to reveal the metal pattern. At 52 the metal pattern is optionally overmolded with an elastomer, such as silicone, in order to fix and protect the conductive traces so formed from environmental stress, such as oxidation, moisture, and mechanical damage.

In some scenarios, the liquid metal, having traversed the pore structure in the unfilled areas of the textile, may further reveal a more detailed indication of the p structure. For instance, if the surface energy of the liquid metal on the substrate is low enough to overcome the tendency of the liquid metal droplets to coalesce, then an indication (or shadow) of the pore structure of the mesh itself may be revealed in the metal pattern. The indication may reveal, for a regular, periodic mesh, periodic deposits of metal arranged at the same pitch as the pores of the mesh. Contributing to this effect may be the formation of an oxide ‘skin’ on the emerging metal. An indication of the pore structure of the mesh may be revealed by close examination of the metal pattern, in some examples. In other scenarios, the liquid metal, upon reaching the substrate, may coalesce thereon to a greater degree. The coalescence of the liquid metal may leave no sign of the detailed pore structure of the textile, but may smooth out the shadowing effect of the mesh.

No aspect of the above drawings or description should be interpreted in a limiting sense, for numerous variations, extensions, and omissions are envisaged as well. For instance, fibers other than metallic or metalized fibers may be wetted by liquid metals under suitable conditions and usable in the above method. Other materials having this property may include gallium oxide and certain germanium-based glasses. If such materials are incorporated into a textile, they may be a suitable substitute for the other metal-containing textiles described above. Moreover, the patterning of liquid metal on a substrate is applicable to numerous uses besides forming traces within flexible electronic components. Examples include, but are not limited to patterning electrooptical componentry and replicating decorative patterns on consumer goods. Although liquid-alloys of gallium are emphasized above, the configurations and methods set forth herein are applicable to the patterning of other metals as well. This includes metals such as mercury (in applications where toxicity of this metal can be controlled), and chemically aggressive alkali-metal alloys such as sodium-potassium alloy (NaK). Patterned coatings of alkali-metal alloys may be used to stimulate subsequent surface chemistry in correspondingly patterned areas of a substrate. Finally, it is also envisaged that the above methods may be applied to an alloy that is liquid at the temperatures used during the screen printing, but which subsequently solidifies on the substrate, to form a solid coating. In such an example, a post-printing encapsulation step may be avoided

Another example provides a method to deposit a metal pattern onto a substrate. The method comprises placing a textile over the substrate, the textile having a plurality of pores wettable by a liquid metal; forcing the liquid metal through the pores of the textile and onto the substrate; and separating the substrate and the textile.

In some implementations, the textile includes a pore-patterned textile comprising a pattern of filled pores and unfilled pores. In some implementations, the liquid metal includes an alloy of gallium with one or more of indium and tin. In some implementations, the textile comprises a metal. In some implementations, the textile comprises metallized fibers. In some implementations, the textile comprises metal fibers. In some implementations, the liquid metal forms an alloy with the metal of the textile. In some implementations, the metal comprises one or more of copper, silver, gold, nickel, iron, and tin. In some implementations, forcing the liquid metal through the pores includes applying mechanical force. Another example comprises a metal pattern formed by the above method.

Another example provides a method for depositing a metal pattern onto a substrate. The method comprises placing a metal-containing textile over the substrate, the metal-containing textile having a plurality of pores wettable by a liquid metal; forcing the liquid metal through the pores of the metal-containing textile and onto the substrate; and separating the substrate and the metal-containing textile.

In some implementations, the liquid metal forms an alloy with a metal of the metal-containing textile. In some implementations, the liquid metal comprises gallium alloyed with one or snore of indium and tin.

Another example provides a textile for screen printing a metal pattern onto a substrate. The textile comprises an arrangement of metal-containing fibers defining a plurality of pores wettable by a liquid metal; and a pore-filling solid permeating the intimate arrangement of metal-containing fibers within a defined area, thereby defining a pattern of filled and unfilled pores.

In some implementations, the arrangement of metal-containing fibers includes a knit or woven mesh. In some implementations, the arrangement of metal-containing fibers is non-woven or felted. In some implementations, the metal-containing fibers are metallic. In some implementations, the metal-containing fibers are metalized. In some implementations, the metal-containing fibers include an electroless deposition of metal. In some implementations, the metal-containing fibers include one or more of copper, silver, gold, nickel, iron, indium, and tin.

It will be understood that the configurations and/or approaches described herein are exemplary in nature, and that these specific implementations or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method to deposit a metal pattern onto a substrate, the method comprising:
placing a textile over the substrate, the textile having a plurality of pores wettable by a liquid metal;
forcing the liquid metal through the pores of the textile and onto the substrate; and
separating the substrate and the textile.

2. The method of claim 1, wherein the textile is a pore-patterned textile comprising a pattern of filled pores and unfilled pores.

3. The method of claim 1, wherein the liquid metal includes an alloy of gallium with one or more of indium and tin.

4. The method of claim 1, wherein the textile comprises a metal.

5. The method of claim 4, wherein the textile comprises metallized fibers.

6. The method of claim 4, wherein the textile comprises metal fibers.

7. The method of claim 4, wherein the liquid metal forms an alloy with the metal of the textile.

8. The method of claim 4, wherein the metal comprises one or more of copper, silver, gold, nickel, iron, and tin.

9. The method of claim 1, wherein forcing the liquid metal through the pores includes applying mechanical force.

10. A metal pattern formed by the method of claim 1.

11. A method for depositing a metal pattern onto a substrate, the method comprising:
placing a metal-containing textile over the substrate, the metal-containing textile having a plurality of pores wettable by a liquid metal;
forcing the liquid metal through the pores of the metal-containing textile and onto the substrate; and
separating the substrate and the metal-containing textile.

12. The method of claim 11, wherein the liquid metal forms an alloy with a metal of the metal-containing textile.

13. The method of claim 11, wherein the liquid metal comprises gallium alloyed with one or more of indium and tin.

14. A textile for screen printing a metal pattern onto a substrate, the textile comprising:
an arrangement of metal-containing fibers defining a plurality of pores wettable by a liquid metal; and
a pore-filling solid permeating the intimate arrangement of metal-containing fibers within a defined area, thereby defining a pattern of filled and unfilled pores.

15. The textile of claim 14, wherein the arrangement of metal-containing fibers includes a knit or woven mesh.

16. The textile of claim 14, wherein the arrangement of metal-containing fibers is non-woven or felted.

17. The textile of claim 14, wherein the metal-containing fibers are metallic.

18. The textile of claim 14, wherein the metal-containing fibers are metalized.

19. The textile of claim 14, wherein the metal-containing fibers include an electroless deposition of metal.

20. The textile of claim 14, wherein the metal-containing fibers include one or more of copper, silver, gold, nickel, iron, indium, and tin.
